(19) United States
(12) Patent Application Publication
(10) Pub. No.: US 2015/0041258 A1
(43) Pub. Date: Feb. 12, 2015

(54) Mount for a Contact Conductor of a Device for Monitoring Brake Pad Wear

(71) Applicant: KNORR-BREMSE Systeme fuer Nutzfahrzeuge GmbH, Muenchen (DE)

(72) Inventor: Alexander ASEN, Eichendor (DE)

(21) Appl. No.: 14/523,203

(22) Filed: Oct. 24, 2014

Related U.S. Application Data
(63) Continuation of application No. PCT/EP2013/001266, filed on Apr. 26, 2013.

(30) Foreign Application Priority Data
Apr. 27, 2012 (DE) 102012008572.9

(51) Int. Cl. F16L 3/00; F16D 66/02; B60T 17/22

(52) U.S. Cl. CPC F16L 3/00; B60T 17/22; F16D 66/021
USPC 188/1.11 L; 248/65

(57) ABSTRACT

A mount is provided for fastening a contact conductor of a brake pad wear monitoring device of a disc brake, in particular of a commercial vehicle, on a brake caliper. The contact conductor is secured in a cable guide, which bears against a retaining bracket which extends across a mounting opening of the brake caliper. The cable guide is covered by a cover. The cable guide and/or the cover have at least one spacer element which is arranged in an intermediate space accommodating the contact conductor and bounds the height of the latter.

### CROSS REFERENCE TO RELATED APPLICATIONS

This application is a continuation of PCT International Application No. PCT/EP2013/001266, filed Apr. 26, 2013, which claims priority under 35 U.S.C. §119 from German Patent Application No. 10 2012 008 572.9, filed Apr. 27, 2012, the entire disclosures of which are herein expressly incorporated by reference.

### BACKGROUND AND SUMMARY OF THE INVENTION

The invention relates to the mounting of a contact conductor (line) of an apparatus for monitoring brake pad wear of a disc brake, in particular of a commercial vehicle disc brake, to a brake caliper, the contact conductor being held in a separate cable guide which bears against a retaining bracket spanning a mounting opening of the brake caliper. A mount of this type is known from WO 2008/060392 A1.

Here, contact conductors in the form of cables are provided for monitoring the friction lining thickness, in particular for determining a permissible wear limit of the friction lining of a brake pad, which contact conductors are embedded in regions into the friction lining and, if a wear limit is reached, are ground by a brake disc which is in contact with the friction lining during a braking operation. As a result, an electrical pulse is output to a signal transmitter. The latter indicates that it is necessary to replace the brake pad.

The contact conductor is mounted to the brake caliper firstly for protection and secondly for preventing uncontrolled movements, in particular in the case of vibrations as a result of driving. To be precise the contact conductor is mounted (fastened) in a cable guide which rests on a retaining bracket, which bracket spans a mounting opening of the brake caliper, and is covered by a cover usually made from sheet metal. Clamping lugs are provided on the separate cable guide for fixed positioning of the contact conductor, by way of which clamping lugs the contact conductor is held in a positively locking and/or frictional manner.

The cable guide, which as a rule is composed of plastic, engages in a positively locking manner into the retaining bracket, connected wear contacts first of all being inserted into a brake pad support plate during mounting of the contact conductor. The cable guide then is fastened to the retaining bracket, before the contact conductor is clamped fixedly in the cable guide and the cover plate is positioned so as to cover the contact conductor and the cable guide.

However, problems arise, above all, by virtue of the fact that, during mounting or dismantling of a wheel which is assigned to the disc brake, the wheel rim can strike against the covering plate, which frequently occurs in practice and is therefore complained about, insofar as the contact conductor is squashed and often damaged to the point of a functional failure in the process. This risk cannot be ruled out entirely even in the case of careful handling. The failure of the functional capability of the contact conductor ultimately leads to the necessity of replacement, which is naturally associated with considerable complexity, in particular with regard to the costs which are incurred.

DE 10 2008 021 008 A1 discloses a mount for a contact conductor, in which a separate cable guide is not provided, but rather the contact conductors are held by integrally molded and bent-over lugs on a cover which is connected in a positively locking manner to a retaining bracket.

The invention is based on the object of developing a mount of the generic type in such a way that its functional capability is improved and its service life is increased.

This and other objects are achieved by a mount for a contact conductor of an apparatus for monitoring brake pad wear of a disc brake, in particular of a commercial vehicle disc brake, to a brake caliper, the contact conductor being held in a separate cable guide which bears against a retaining bracket spanning a mounting opening of the brake caliper, and is covered by a cover. The cable guide and/or the cover have at least one spacer element which forms an abutment, is arranged in the intermediate space which receives the contact conductor, and delimits the intermediate space vertically.

A vertically defined intermediate space is produced between the cover and the cable guide by way of the spacer element, which intermediate space ensures that the contact conductor, which lies in between, is not loaded in the sense of being squashed even if the cover is loaded by way of impact or resting of a foreign body, for example the above-mentioned wheel rim.

The spacer element (two spacer elements which are arranged at a spacing from one another are preferably provided) therefore assumes the function of an abutment which dissipates the forces which act on the cover.

According to one advantageous development of the invention, the spacer elements are molded integrally onto the cable guide which, as has already been mentioned, is usually configured as an injection molded part. That is to say, the invention can be realized in a largely cost-neutral manner.

This is likewise the result if, as an alternative or in addition, the spacer elements are provided on the cover, which is configured as a punched sheet metal part, with the spacer elements which are made by way of punching or stamping.

The invention then results in a whole series of advantages in comparison with a known mount. Since damage of the contact conductor within the mount is ruled out as it were, even in very unfavorable conditions, the service life of the mounting of the contact conductor of course increases, which service life is then determined exclusively by the actual function, namely the wear sensing of the friction lining.

As a consequence, this results in a certainly noticeable cost savings, since premature replacing of the mount including the contact conductor is no longer required, which has been possible up to now, as described, only with considerable mounting complexity, including the possibly necessary dismantling of the disc brake overall.

It is provided according to one advantageous development of the invention to equip the cable guide with additional contact conductor receptacles which ensure precisely defined guidance of the contact conductor.

To this end, for example, two contact conductor guides can be provided, which lie directly next to one another and which make it possible to form a double loop course of the contact conductor. As a result, a strong attachment of the contact conductor is achieved.

It is provided according to a further aspect of the invention to configure the spacer elements in a block-like manner. This has the result that a sufficiently large support surface is provided for the cover. The cover is latched to the retaining bracket in a manner known per se, with the result that the cover, as it were, assumes a double function, of firstly the protection of the contact conductor and secondly the locking of the cable guide on the retaining bracket.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view showing a detail of a cable guide of the mount according to an embodiment of the invention;

FIG. 2 shows the embodiment of the invention in a partially mounted position, likewise shown perspectively; and

FIG. 3 shows a completed mount, likewise in a perspective view.

### DETAILED DESCRIPTION OF THE DRAWINGS

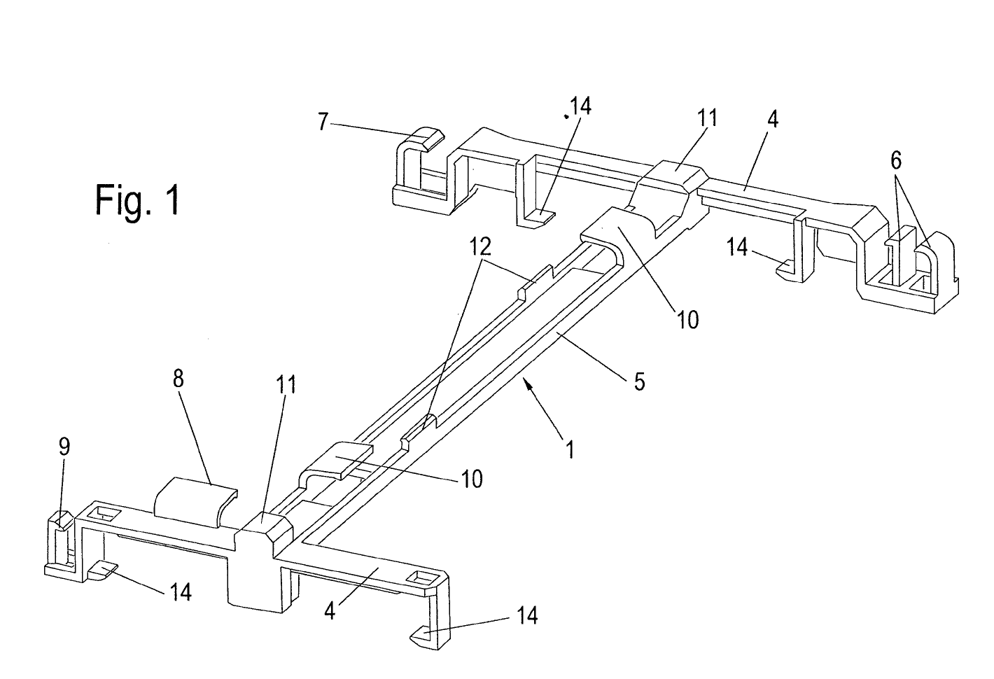

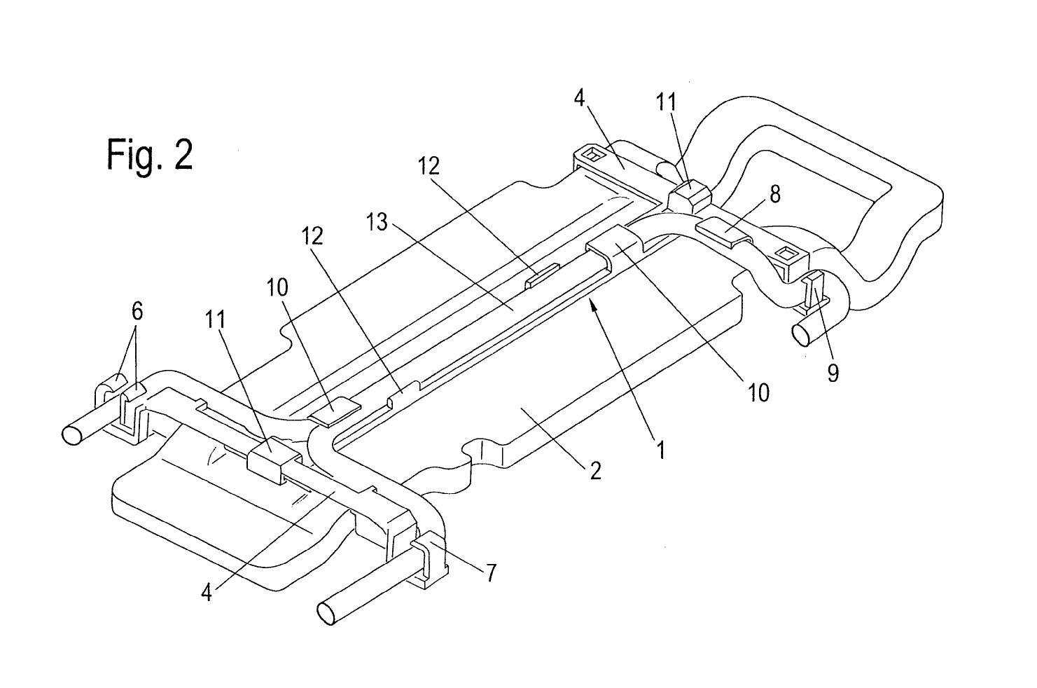

FIG. 1 shows a cable guide 1 of a mount for fastening a contact conductor 13 (FIG. 2), which are constituent parts of an apparatus for monitoring brake pad wear of a disc brake, in particular of a commercial vehicle disc brake, on a brake caliper (not shown).

Here, the contact conductor 13 is held in the cable guide 1 which is shown as a detail in FIG. 1, in a manner which corresponds to the illustration in FIG. 2.

Furthermore, FIG. 2 shows the arrangement of the cable guide 1 on a retaining bracket 2, which bracket spans a mounting opening of the brake caliper and against which the cable guide 1 bears.

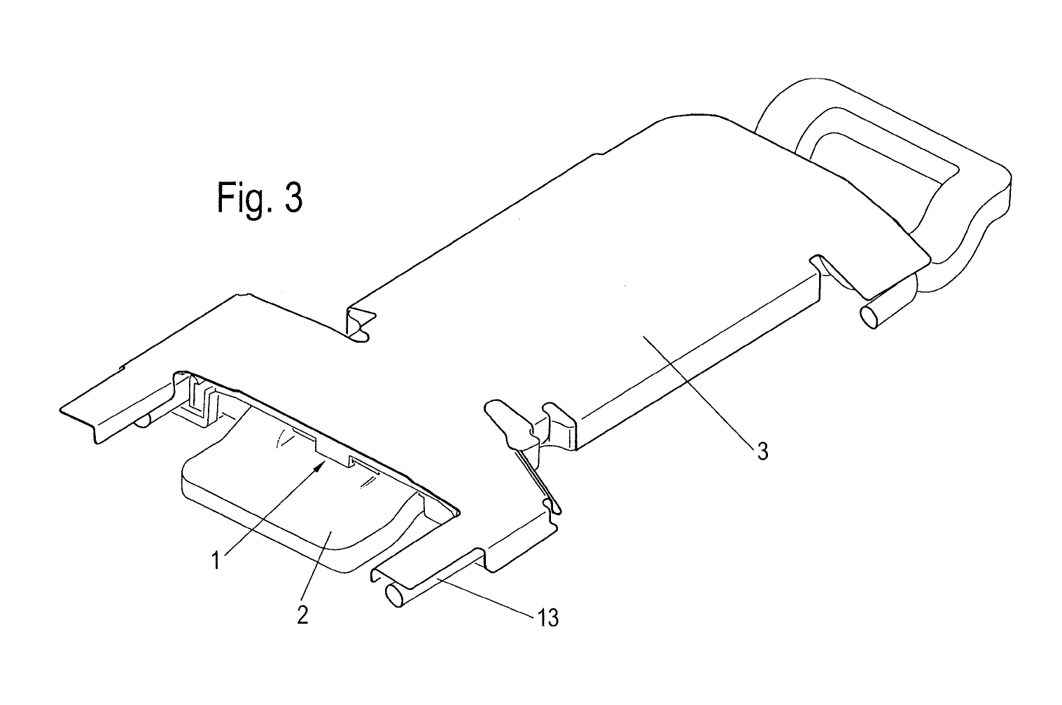

Finally, FIG. 3 shows the completed mount, the cable guide 1 with installed contact conductor 13 being covered by a cover 3 which is latched to the retaining bracket 2.

The cable guide 1, which is shown in detail in FIG. 1, is fastened to the retaining bracket 2 in a manner which is shown rotated by 180° in the plane in FIG. 2, whereas FIG. 3 as it were shows the final position of the mount, in which the cover 3 is latched to the retaining bracket 2 and/or the cable guide 1.

According to an embodiment of the invention, the cable guide 1 has spacer elements 11, which are molded integrally onto the cable guide 1. The cable guide 1 is composed of plastic. The spacer elements 11 are arranged in the intermediate space which receives the contact conductor 13 between the cover 3 and the cable guide 1, and against which the cover 3 bears.

Here, the height of the spacer elements 11 is greater than the diameter of the contact conductor 13.

The cable guide 1 is formed in an I-shape with two limbs 4, which are arranged parallel and spaced apart from one another, and a strut 5 which connects the limbs 4.

One of the limbs 4 (to be precise, the upper limb 4 in FIG. 1) has clips 6, 7 on an end side, in which the guided contact conductor 13 is held.

The right-hand clip 6 is configured as a double clip, with the result that the guided contact conductor 13 can be inserted in two loops.

The limb 4 which lies opposite is likewise provided with a clip 9, for receiving the contact conductor 13 which is otherwise guided and fastened on the strut 5 by way of clips 10, whereas stops 12 which are integrally molded in a laterally offset manner form a contact conductor guide.

Otherwise, an additional contact conductor clip 8 is provided on the lower limb 4, by means of which additional contact conductor clip 8 the contact conductor 13 is also held reliably at this point.

The cable guide 1 is fastened to the retaining bracket 2 by way of bearing hooks 14, which are integrally molded on both limbs 4. The bearing hooks 14 engage under the retaining bracket 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A mount for fastening a brake pad wear monitoring contact conductor to a caliper of a disc brake having a retaining bracket that spans an opening of the caliper, comprising:
a cable guide configured to bear against the retaining bracket;
a cover configured to cover the cable guide, wherein
the cable guide and/or the cover comprises at least one spacer element forming an abutment, the spacer element being arranged in an intermediate space that receives the contact conductor, and
the spacer element delimiting a vertical height of the intermediate space.

2. The mount according to claim 1, wherein the spacer element is molded integrally onto the cable guide and/or the cover.

3. The mount according to claim 2, wherein at least two spacer elements are arranged on the cable guide, said spacer elements being positioned on two limbs of the cable guide that are arranged parallel to one another and spaced apart from one another.

4. The mount according to claim 1, wherein at least two spacer elements are arranged on the cable guide, said spacer elements being positioned on two limbs of the cable guide that are arranged parallel to one another and spaced apart from one another.

5. The mount according to claim 1, wherein a height of the at least one spacer element is dimensioned to be greater than a diameter of the contact conductor.

6. The mount according to claim 3, wherein the height of each spacer element is dimension to be greater than a diameter of the contact conductor.

7. The mount according to claim 1, wherein the cable guide comprises a plurality of clips molded integrally thereon, said plurality of clips being configured to hold the contact conductor.

8. The mount according to claim 6, wherein the cable guide comprises a plurality of clips molded integrally thereon, said plurality of clips being configured to hold the contact conductor.

9. The mount according to claim 8, wherein at least one of said plurality of clips is molded integrally on one of the two limbs.

10. The mount according to claim 9, wherein a double clip of said plurality of clips is provided on an end side of at least one of said limbs.

11. The mount according to claim 3, wherein a double clip of said plurality of clips is provided on an end side of at least one of said limbs.

12. The mount according to claim 1, wherein at least two spacer elements are formed on the cover, which cover is made of sheet metal, and
wherein the spacer elements are formed as punched or stamped protrusions in of the cover.

13. A disc brake having a caliper with a mounting opening, comprising:
a brake pad wear monitoring contact conductor;
a retaining bracket configured to span the mounting opening of the caliper;
a cable guide bearing against the retaining bracket, the cable guide being configured to hold the contact conductor;
a cover that covers the cable guide, wherein
the cable guide and/or cover have at least one spacer element forming an abutment, the spacer element being arranged in an intermediate space in which the contact conductor is received, and
the spacer element delimiting a vertical height of the intermediate space.

14. The disc brake according to claim 13, wherein the spacer element is molded integrally onto the cable guide and/or the cover.

15. The disc brake according to claim 14, wherein the cable guide has an I-shape composed of two limbs arranged parallel and spaced apart from one another, said two limbs being connected by a strut, wherein
a spacer element is arranged on a center portion of each of the two limbs.

16. The disc brake according to claim 15, wherein a height of each spacer element is dimensioned to be greater than a diameter of the contact conductor.

17. The disc brake according to claim 16, wherein the cable guide comprises a plurality of clips molded integrally thereon, said clips being configured to hold the contact conductor.

18. The disc brake according to claim 13, wherein the cover is formed of sheet metal and the at least one spacer element is formed as a stamped or punched portion of the cover.
